(19) United States
(12) Patent Application Publication
(10) Pub. No.: US 2015/0109921 A1
(43) Pub. Date: Apr. 23, 2015

(54) METHOD FOR SWITCHING STATION WORKING MODE AND COMMUNICATIONS DEVICE

(71) Applicant: Huawei Technologies Co., Ltd., Shenzhen (CN)

(72) Inventors: Mu Zhao, Beijing (CN); Yanping Jiang, Beijing (CN); Bin Zhen, Beijing (CN)

(21) Appl. No.: 14/583,463

(22) Filed: Dec. 26, 2014

Related U.S. Application Data
(63) Continuation of application No. PCT/CN2013/075811, filed on May 17, 2013.

(30) Foreign Application Priority Data
Jun. 27, 2012 (CN) 201210215476.8

(51) Int. Cl. H04W 28/06

(52) U.S. Cl. CPC H04W 28/06
USPC 370/230

(57) ABSTRACT

A method includes: obtaining, by a transmit end, switching information of a STA, where the switching information includes that the STA switches to a TIM STA or the STA switches to a Non-TIM STA; and sending, by the transmit end, a first message to a receive end, where the first message includes a flag bit, and the flag bit identifies the switching information. According to the embodiments of the present invention, both a STA and an AP can learn switching of a STA working mode, so that correct switching of the STA can be implemented, and the AP can perform correct processing according to a switching situation of the STA.

### CROSS-REFERENCE TO RELATED APPLICATIONS

This application is a continuation of International Application No. PCT/CN2013/075811, filed on May 17, 2013, which claims priority to Chinese Patent Application No. 201210215476.8, filed on Jun. 27, 2012, both of which are hereby incorporated by reference in their entireties.

### TECHNICAL FIELD

The present invention relates to wireless communications technologies, and in particular, to a method for switching a station (STA) working mode and a communications device.

### BACKGROUND

With the evolution of technologies, a wireless local area network (WLAN, WiFi) supports an intelligent meter reading scenario. In this scenario, a maximum of 6000 STAs may be supported, and some STAs generally send a data packet including meter reading information to an access point (AP) at long intervals. It is recommended that such STAs should work in a working mode in which these STAs do not depend on a traffic indication map (TIM), and these STAs are referred to as Non-TIM STAs; correspondingly, STAs depending on a TIM are referred to as TIM STAs.

In a network supporting a large number of STAs, to reduce a size of a beacon (beacon) and improve efficiency, a TIM needs to be compressed. During the compression, an AP may select to exclude information about a Non-TIM STA from the TIM. To conveniently compress the TIM without the information about the Non-TIM STA, the AP needs to differentiate a TIM STA from the Non-TIM STA; in addition, a STA also needs to learn a to-be-switched working mode so as to work correctly.

### SUMMARY

Embodiments of the present invention provide a method for switching a STA working mode and a communications device, which are used to implement that both a STA and an AP can learn a to-be-switched STA working mode.

According to one aspect, a method for switching a STA working mode is provided, including:

obtaining, by a transmit end, switching information of a STA, where the switching information includes that the STA switches to a traffic indication map station TIM STA or the STA switches to a non-traffic indication map station Non-TIM STA; and

sending, by the transmit end, a first message to a receive end, where the first message includes a flag bit, and the flag bit identifies the switching information.

According to another aspect, a communications device is provided, including:

a obtaining module, configured to obtain switching information of a station STA, where the switching information includes that the STA switches to a traffic indication map station TIM STA or the STA switches to a non-traffic indication map station Non-TIM STA; and

a sending module, configured to send a first message to a receive end, where the first message includes a flag bit, and the flag bit identifies the switching information.

It can be learned from the foregoing technical solutions that a transmit end may notify a receive end of a to-be-switched STA working mode by using a flag bit in a first message, which ensures that both a STA and an AP can learn switching of the STA working mode, so that correct switching of the STA can be implemented, and the AP can perform correct processing according to a switching situation of the STA.

### BRIEF DESCRIPTION OF THE DRAWINGS

FIG. 1 is a schematic flowchart of an embodiment of a method for switching a STA working mode according to the present invention;

FIG. 2 is a schematic flowchart of another embodiment of a method for switching a STA working mode according to the present invention;

FIG. 3 is a schematic flowchart of another embodiment of a method for switching a STA working mode according to the present invention;

FIG. 4 is a schematic flowchart of another embodiment of a method for switching a STA working mode according to the present invention;

FIG. 5 is a schematic flowchart of another embodiment of a method for switching a STA working mode according to the present invention;

FIG. 6 is a schematic structural diagram of an embodiment of a communications device according to the present invention;

FIG. 7 is a schematic structural diagram of another embodiment of a communications device according to the present invention;

FIG. 8 is a schematic structural diagram of another embodiment of a communications device according to the present invention; and

FIG. 9 is a schematic structural diagram of another embodiment of a communications device according to the present invention.

### DETAILED DESCRIPTION

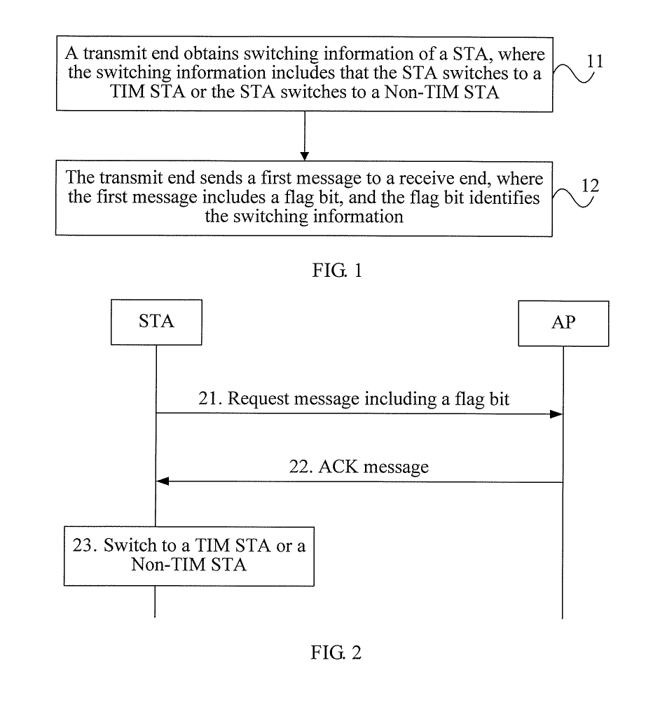

FIG. 1 is a schematic flowchart of an embodiment of a method for switching a STA working mode according to the present invention, where the method includes:

Step 11: A transmit end obtains switching information of a STA, where the switching information includes that the STA switches to a TIM STA or the STA switches to a Non-TIM STA.

Step 12: The transmit end sends a first message to a receive end, where the first message includes a flag bit, and the flag bit identifies the switching information.

In a scenario in which a large number of STAs are supported, the STAs may be classified into TIM STAs and Non-TIM STAs. For one STA, working modes of the STA may be mutually switched, for example, the working mode is switched from the TIM STA to the Non-TIM STA, or switched from the Non-TIM STA to the TIM STA. The switching may be caused in the following two situations:

Situation 1: When an application requirement is changed, for example, when in a period of time, there is a requirement for irregularly querying electricity meter information, a Non-TIM STA needs to be switched to a TIM STA in this case; and when the requirement ends, the TIM STA needs to be switched to the Non-TIM STA.

Situation 2: When an application requirement is newly added, for example, when in addition to reporting a reading, a STA newly adds a function of querying a current or a voltage, the new function requires that the STA switches from an original Non-TIM STA to a TIM STA.

After the STA working mode is switched, to ensure correct subsequent processing, an AP and the STA need to notify each other. For example, if the STA initiates switching of the STA working mode, the STA needs to notify the AP of the switching; and if the AP initiates switching of the STA working mode, the AP needs to notify the STA of the switching.

In this embodiment, a notification between the STA and the AP may be implemented by using the first message.

Optionally, switching of the STA working mode may be initiated by the STA, and in this case, the transmit end is the STA, and the receive end is the AP. The STA may learn, according to configuration information, a working mode to which the STA needs to switch. For example, the STA itself needs to change an application requirement or newly add an application requirement; or

Optionally, switching of the STA working mode may be initiated by the AP, and in this case, the transmit end is the AP, and the receive end is the STA. The AP may indicate a working mode to which the STA needs to switch, for example, the AP instructs the STA to change an application requirement or newly add an application requirement.

Optionally, when the STA initiates the switching, after obtaining that the STA needs to switch the working mode, the STA may perform switching. For example, if it is required to switch to the TIM STA, the STA switches from the Non-TIM STA to the TIM STA; or if it is required to switch to the Non-TIM STA, the STA switches from the TIM STA to the Non-TIM STA.

In addition, the switching maybe performed after a response message, sent by the AP, of the first message is received; or may also be performed though the response message is not received. Alternatively, the response message is received, but switching is performed before the response message is received.

Generally, association identifiers (Association Identifier, AID) of the TIM STA and the Non-TIM STA are classified into different groups. For example, each of 1 to 10 identifies a TIM STA, and each of 11 to 20 identifies a Non-TIM STA.

After the STA switches the working mode, the AP may reallocate a new AID to the STA. For example, if the STA is a TIM STA originally, the AID of the STA belongs to 1 to 10. After the STA switches to a Non-TIM STA, the AP may allocate a new AID from 11 to 20 to the STA.

Optionally, when the response message is received, the response message may include a new AID, and in this case, the STA uses the new AID; or the response message may also not include a new AID, and in this case, the STA continues to use an existing AID.

In addition, when the transmit end is the STA, and the receive end is the AP, the first message is a unicast message.

Optionally, when the transmit end is the AP, and the receive end is the STA, the first message may be a unicast message or may also be a multicast message. For example, the AP sends the first message to the STAs one by one, or the AP sends the first message to a group of STAs.

When the first message is a multicast message, the STA serving as the receive end refers to any STA in a STAs, group in which all STAs need to switch from Non-TIM STAs to TIM STAs, or any STA in a STA group in which all STAs need to switch from TIM STAs to Non-TIM STAs.

Optionally, when the transmit end is the AP, and the receive end is the STA, the first message may also include a new AID, or not include a new AID. When a new AID is included, the AP allocates the new AID to the STA; when the STA needs to switch to the TIM STA, a group in which the new AID belongs is a group corresponding to the TIM STA; and when the STA needs to switch to the Non-TIM STA, a group in which the new AID belongs is a group corresponding to the Non-TIM STA. In this case, the STA uses the new AID. When a new AID is not included, the STA continues to use an existing AID.

Optionally, for the first message sent by the AP to the STA or the first message sent by the STA to the AP, the first message may be a newly added message or an existing message.

In addition, the “message” in this embodiment of the present invention generally refers to a carrier capable of transmitting information, and may be referred to as a management frame, a data frame, signaling, a data packet, a packet, or the like.

In this embodiment, a STA and an AP may notify each other of switching of a STA working mode by using a first message, which ensures that both the STA and the AP can learn the switching of the STA working mode, so that correct switching of the STA can be performed, and the AP can perform correct processing according to a switching situation of the STA.

FIG. 2 is a schematic flowchart of another embodiment of a method for switching a STA working mode according to the present invention. In this embodiment, that a STA initiates switching is used as an example; and in this embodiment, a first message is specifically a request message, and a response message of the first message is specifically an ACK message corresponding to the request message. A method includes:

Step 21: After an application requirement of the STA is changed or an application requirement is newly added, a STA sends a request message (REQ) to an AP, where the request message includes a flag bit, and the flag bit indicates that the STA needs to switch to a TIM STA or a Non-TIM STA. That is, the STA obtains switching information of the STA, and the flag bit identifies the switching information, where the switching information includes that the STA switches to the TIM STA or switches to the Non-TIM STA.

For a specific situation that the application requirement is changed or the application requirement is newly added, refer to the foregoing description.

A specific value of the flag bit may be denoted by “1” or “0”. For example, when the STA needs to switch from the Non-TIM STA to the TIM STA, the flag bit is denoted by “1”, and when the STA needs to switch from the TIM STA to the Non-TIM STA, the flag bit is denoted by “0”.

Step 22: After receiving the request message, the AP determines that the STA needs to switch to the TIM STA or the Non-TIM STA, and sends an ACK message to the STA.

After determining that a STA working mode is switched, the AP may provide the basis for correct subsequent processing. For example, after determining that a STA switches from a TIM STA to a Non-TIM STA, the AP may not include information about the STA in a TIM when sending the TIM.

In addition, after determining that the STA working mode is switched, if there is an available AID resource, the AP may allocate a new AID to the STA, and include the new AID in the ACK message and send the ACK message to the STA. Alternatively, the AP may also not allocate the new AID and only send the ACK message.

Step 23: After receiving the ACK message, the STA switches to the TIM STA or the Non-TIM STA.

In this embodiment, that switching is performed after the STA receives the ACK message is used as an example, and as described above, the STA may also perform switching immediately after the application requirement of the STA is changed or the application requirement is newly added, regardless of whether the ACK message is received.

In addition, when the ACK message sent by the AP includes a new AID, the STA uses the new AID and feeds back an ACK message to the AP. If the ACK message sent by the AP does not include a new AID, the STA continues to use an existing AID.

Optionally, after sending the request message, if the STA does not receive, in a set time , the ACK message (including or excluding a new AID) fed back by the AP, the STA may resend the request message.

Optionally, if the AP allocates a new AID and does not receive, in a set time, the ACK message fed back by the STA, the AP may resend the new AID.

In this embodiment, after initiating switching, a STA may notify an AP of the switching by using a request message, which ensures that both the STA and the AP can learn switching of a STA working mode, so that correct switching of the STA can be implemented, and the AP can perform correct processing according to a switching situation of the STA.

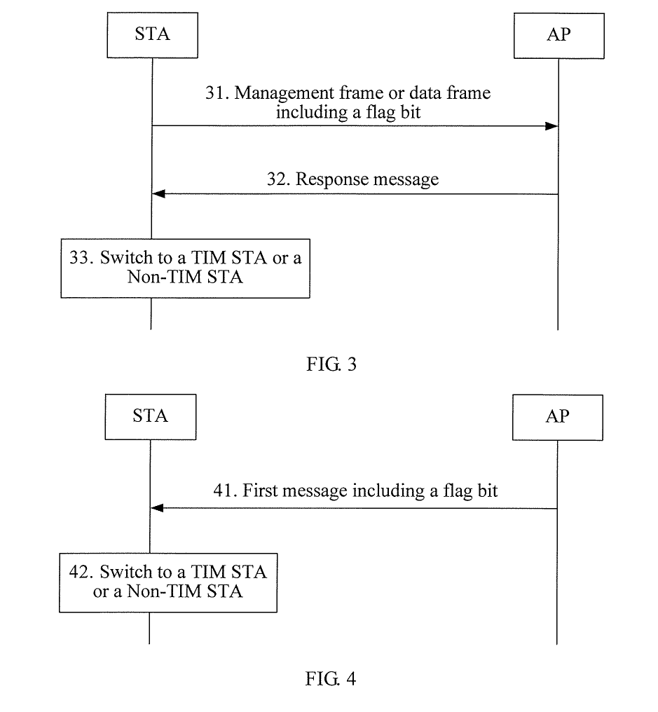

FIG. 3 is a schematic flowchart of another embodiment of a method for switching a STA working mode according to the present invention. In this embodiment, that a STA initiates switching is used as an example; and in this embodiment, a first message and a response message of the first message are specifically existing messages. This embodiment includes:

Step 31: After an application requirement of the STA is changed or an application requirement is newly added, when sending a management frame or a data frame to an AP, the STA includes a flag bit in the management frame or the data frame, where the flag bit indicates that the STA needs to switch to a TIM STA or a Non-TIM STA.

The management frame or the data frame includes but is not limited to: an association frame, a reassociation frame, a PS-poll frame, a trigger frame, and a data frame.

The flag bit may be a bit reserved in these existing frames, or may also be a flag bit added into the existing frames. A specific value of the flag bit maybe denoted by “1” or “0”. For example, when the STA needs to switch from the Non-TIM STA to the TIM STA, the flag bit is denoted by “1”, and when the STA needs to switch from the TIM STA to the Non-TIM STA, the flag bit is denoted by “0”.

Step 32: After receiving the existing frame, the AP determines that the STA needs to switch to the TIM STA or the Non-TIM STA, and sends a response message to the STA.

The response message is, for example, association confirmation, reassociation confirmation, ACK, or DATA.

In addition, after determining that a STA working mode is switched, if there is an available AID resource, the AP may allocate a new AID to the STA, and add the new AID into the response message and send the response message to the STA. Alternatively, the AP may also not allocate the new AID and only send the response message.

Step 33: After receiving the response message, the STA switches to the TIM STA or the Non-TIM STA.

In this embodiment, that switching is performed after the STA receives the response message is used as an example, and as described above, the STA may also perform switching after an application requirement of the STA is changed or an application requirement is newly added, regardless of whether the response message is received.

In addition, when the response message sent by the AP includes a new AID, the STA uses the new AID and feeds back an ACK message to the AP. If the response message sent by the AP does not include a new AID, the STA continues to use an existing AID.

Optionally, after sending a request message, if the STA does not receive, in a set time, the response message (including or excluding a new AID) fed back by the AP, the STA may include the flag bit again in a management frame or a data frame to be sent next time.

Optionally, if the AP allocates a new AID and does not receive, in a set time, the ACK message fed back by the STA, the AP may include the new AID again in a management frame or a data frame to be sent next time.

In this embodiment, after initiating switching, a STA may notify an AP of the switching, which ensures that both the STA and the AP can learn switching of a STA working mode, so that correct switching of the STA can be implemented, and the AP can perform correct processing according to a switching situation of the STA. In addition, in this embodiment, a new message may not be added, and an existing message continues to be used.

FIG. 4 is a schematic flowchart of another embodiment of a method for switching a STA working mode according to the present invention; in this embodiment, that an AP initiates switching is used as an example, and this embodiment includes:

Step 41: When the AP needs to change an application requirement of a STA or newly add an application requirement, the AP sends a first message to the STA, where the first message includes a flag bit, and the flag bit indicates that the STA needs to switch to a TIM STA or a Non-TIM STA. That is, the AP obtains switching information of the STA, and the flag bit identifies the switching information, where the switching information includes that the STA switches to the TIM STA or switches to the Non-TIM STA.

The first message may be a newly added message, or may also be an existing management frame, data frame, or the like.

A specific value of the flag bit may be denoted by “1” or “0”. For example, when the STA needs to switch from the Non-TIM STA to the TIM STA, the flag bit is denoted by “1”, and when the STA needs to switch from the TIM STA to the Non-TIM STA, the flag bit is denoted by “0”.

In addition, when there is an available AID resource, the AP may allocate a new AID to the STA, add the new AID into the first message and send the first message to the STA. Alternatively, the AP may also not allocate the new AID and only send the first message.

Step 42: After receiving the first message, the STA sends an ACK message to the AP, and switches to the TIM STA or the Non-TIM STA according to an indication of the first message.

In addition, when the first message includes a new AID, the STA uses the new AID, and when the first message does not include a new AID, the STA continues to use an existing AID.

Optionally, after sending the first message, if the AP does not receive, in a set time, the ACK message fed back by the STA, the AP may resend a new message including the flag bit, or include the flag bit in a management frame or a data frame to be sent next time.

In this embodiment, after initiating switching, an AP may notify a STA of the switching by using a first message, which ensures that both the STA and the AP can learn switching of a STA working mode, so that correct switching of the STA can be implemented, and the AP can perform correct processing according to a switching situation of the STA.

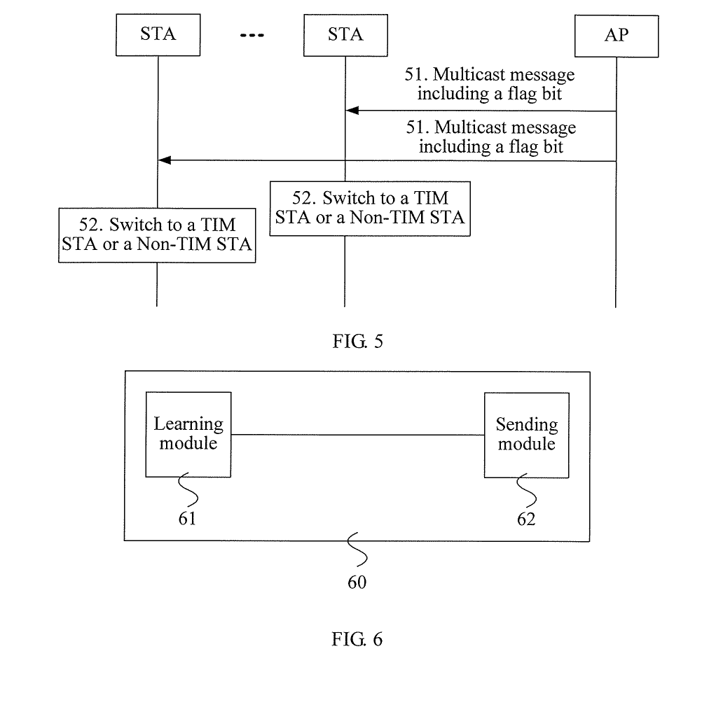

FIG. 5 is a schematic flowchart of another embodiment of a method for switching a STA working mode according to the present invention; in this embodiment, that an AP initiates switching and sends a multicast is used as an example, and this embodiment includes:

Step 51: The AP sends a multicast message to a group of STAs, where the multicast message includes a flag bit, and the flag bit indicates that the STA needs to switch to a TIM STA or a Non-TIM STA.

When multiple STAs need to perform same switching, for example, when all the multiple STAs need to switch from Non-TIM STAs to TIM STAs, or all the multiple STAs need to switch from TIM STAs to Non-TIM STAs, the multicast message may be used to instruct all these STAs to perform the switching.

A specific value of the flag bit may be denoted by “1” or “0”. For example, when all the STAs need to switch from the Non-TIM STAs to the TIM STAs, the flag bit is denoted by “1”, and when all the STAs need to switch from the TIM STAs to the Non-TIM STAs, the flag bit is denoted by “0”.

In addition, when there are available AID resources, the AP may allocate new AIDs to the STAs, and add the new AIDs into the multicast message and send the multicast message to the STAs. Alternatively, the AP may also not allocate new AIDs and only send the multicast message.

When the multicast message includes AIDs, a mapping relationship between the included AIDs and the STAs may be preset, so that each STA can correctly receive an AID of the STA itself . For example, the AIDs are sorted according to an order of serial numbers of the STAs. For example, an AID at a location 1 is an AID of a STA with a serial number 1, and an AID at a location 2 is an AID of a STA with a serial number 2. Alternatively, related AID information included in the multicast message includes not only new AIDs, but also original AIDs. For example, related AID information corresponding to a STA includes AID1′ and AID1, and this indicates that a new AID of a STA corresponding to an original AID1 is AID1′. Each STA may determine a new AID of the STA itself according to an original AID.

Step 52: After receiving the multicast message, the STA sends an ACK message to the AP, and switches to the TIM STA or the Non-TIM STA according to an indication of the multicast message.

In addition, when the multicast message includes a new AID, the STA uses the new AID, and when the multicast message does not include a new AID, the STA continues to use an existing AID.

Optionally, after sending the multicast message, if the AP does not receive, in a set time, the ACK message fed back by the STA, the AP may resend a new message including the flag bit, or include the flag bit in a management frame or a data frame to be sent next time. In addition, the resent message may be a multicast message, or may also be a unicast message.

In this embodiment, after initiating switching, an AP may notify a STA of the switching by using a multicast message, which ensures that both the STA and the AP can learn switching of a STA working mode, so that correct switching of the STA can be implemented, and the AP can perform correct processing according to a switching situation of the STA. In addition, in this embodiment, multiple STAs may be instructed at the same time to perform the switching, by using the multicast message, which reduces a message overhead.

FIG. 6 is a schematic structural diagram of an embodiment of a communications device according to the present invention. A communications device 60 may be an AP or a STA in a WLAN system, and includes An obtaining module 61 and a sending module 62. The obtaining module 61 is configured to obtain switching information of a STA, where the switching information includes that the STA switches to a TIM STA or the STA switches to a Non-TIM STA; and the sending module 62 is configured to send a first message to a receive end, where the first message includes a flag bit, and the flag bit indicates that the STA needs to switch to the TIM STA or the Non-TIM STA.

Optionally, the device is the STA, and the receive end is an AP.

Correspondingly, when an application configuration is changed or an application configuration is added, the obtaining module may specifically learn that the STA needs to switch to the TIM STA or the Non-TIM STA.

Optionally, the STA may further include:

a switching module, configured to switch to the TIM STA or the Non-TIM STA according to the switching information.

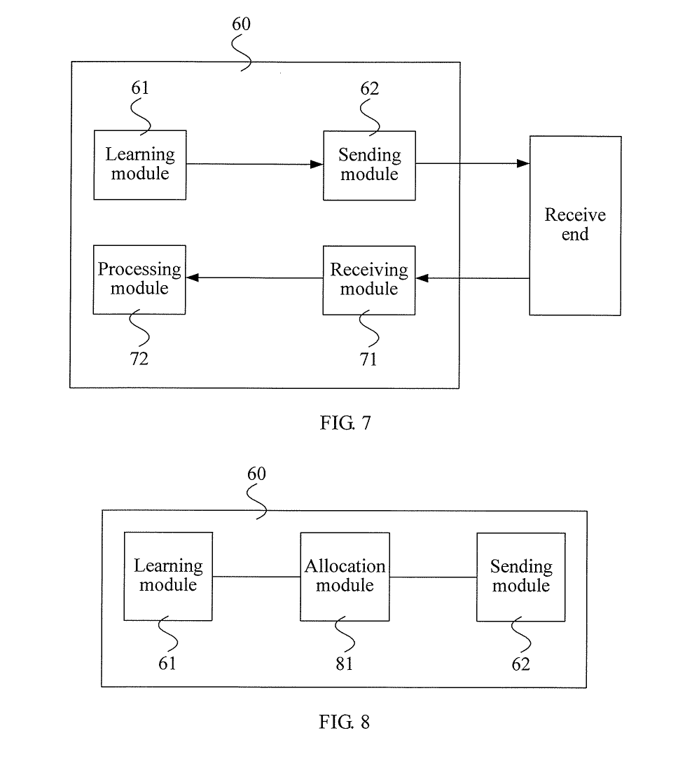

Optionally, referring to FIG. 7, the STA may further include:

a receiving module 71, configured to receive a response message, sent by the AP, of the first message.

Optionally, the STA may further include:

a processing module 72, configured to: when the response message includes a new AID, start to use the new AID; or when the response message does not include a new AID, continue to use an existing AID.

Optionally, the device is the AP, and the receive end is a STA.

Correspondingly, when it is indicated that an application configuration of the STA is changed or an application configuration is added in the STA, the obtaining module may specifically learn that the STA needs to switch to the TIM STA or the Non-TIM STA.

Optionally, the first message is a multicast message, and the STA is any STA in a STA group in which all STAs need to switch from Non-TIM STAs to TIM STAs, or any STA in a STA group in which all STAs need to switch from TIM STAs to Non-TIM STAs.

Optionally, referring to FIG. 8, the first message includes a new AID, and the AP further includes:

an allocation module 81, configured to allocate the new AID to the STA, where when the STA needs to switch to the TIM STA, a group in which the new AID belongs is a group corresponding to the TIM STA, and when the STA needs to switch to the Non-TIM STA, a group in which the new AID belongs is a group corresponding to the Non-TIM STA. In this case, the sending module may add the new AID allocated by the allocation module and the flag bit into the first message and send the first message to the receive end.

In this embodiment, a STA and an AP may notify each other of switching of a STA working mode by using a first message, which ensures that both the STA and the AP can learn the switching of the STA working mode, so that correct switching of the STA can be implemented, and the AP can perform correct processing according to a switching situation of the STA.

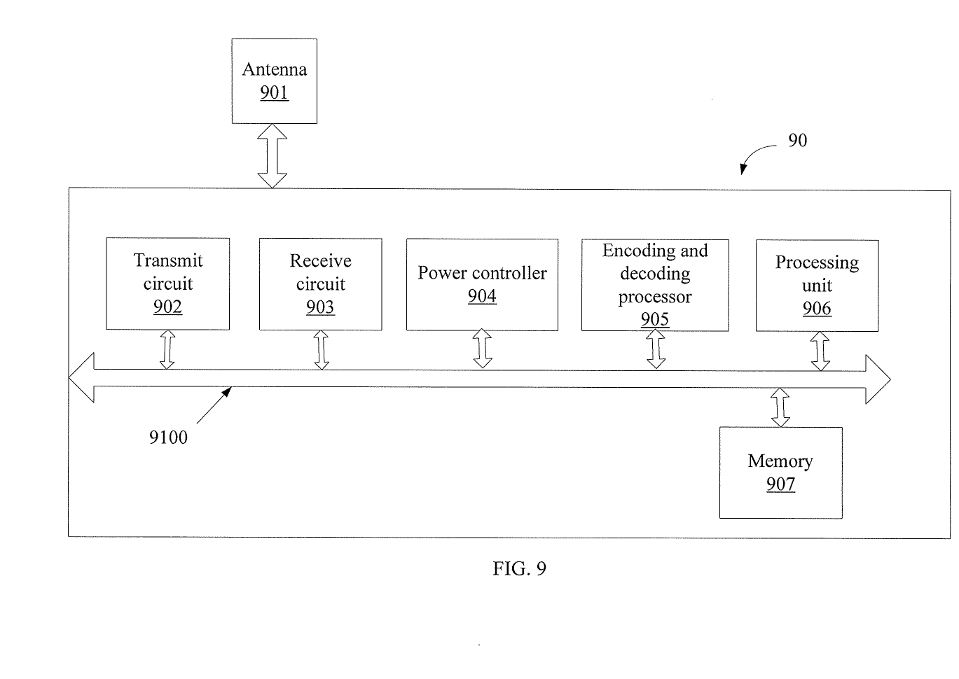

An embodiment of the present invention further provides an apparatus embodiment for implementing the steps and the methods in the method embodiments. This embodiment of the present invention may be applied to an AP or a STA in various communications systems. The AP is, for example, an AP of an operator, an AP disposed in a business shop (such as Starbucks), an AP disposed at home, or the like; and the STA is, for example, an iPad, a PC, or the like. FIG. 9 shows an embodiment of a communications device, and in this embodiment, a device 90 includes a transmit circuit 902, a receive circuit 903, a power controller 904, an encoding and decoding processor 905, a processing unit 906, a memory 907, and an antenna 901. The processing unit 906 controls operations of the device 90, and the processing unit 906 may further be referred to as a CPU. The memory 907 may include a read-only memory and a random access memory, and provide instructions and data to the processing unit 906. A part of the memory 907 may further include a non-volatile random access memory (NVRAM). In a specific application, the device 90 may be built in or the device 90 itself may be a wireless communications device such as a mobile phone, and may further include a carrier accommodating the transmit circuit 902 and the receive circuit 903, so as to allow data transmission and receiving between the device 90 and a remote device. the device 90 may be a network or a wireless device. The transmit circuit 902 and the receive circuit 903 maybe coupled to the antenna 901. Components of the device 90 are coupled together by using a bus system 9100, and in addition to a data bus, the bus system 9100 further includes a power bus, a control bus, and a status signal bus. However, for clear description, the various buses in the figure are marked as the bus system 9100. The device 90 may include the processing unit 906 configured to process a signal, and further includes the power controller 904 and the encoding and decoding processor 905.

The methods disclosed in the embodiments of the present invention may be applied to the processing unit 906 and the transmit circuit 902, or may be implemented by the processing unit 906 and the transmit circuit 902.

For example, the processing unit 906 obtains switching information of a STA, where the switching information includes that the STA switches to a TIM STA or the STA switches to a Non-TIM STA; and the transmit circuit 902 sends a first message to a receive end, where the first message includes a flag bit, and the flag bit identifies the switching information.

Optionally, when a transmit end and the receive end are the STA and the AP respectively, the processing unit 906 is further configured to switch to the TIM STA or the Non-TIM STA according to the switching information.

Optionally, implementation of the methods is further applied to the receive circuit 903. For example, the receive circuit 903 receives a response message, sent by the AP, of the first message; and the processing unit 906 is further configured to: when the response message includes a new association identifier AID, enable the STA to use the new AID; or when the response message does not include a new AID, enable the STA to continue to use an existing AID.

Optionally, when the transmit end and the receive end are the AP and the STA respectively, the processing unit 906 is further configured to allocate a new AID to the STA, where when the STA needs to switch to the TIM STA, a group in which the new AID belongs is a group corresponding to the TIM STA, and when the STA needs to switch to the Non-TIM STA, a group in which the new AID belongs is a group corresponding to the Non-TIM STA.

In an implementation process, when the steps of the methods are implemented by the processing unit 906, the steps of the methods may be specifically implemented by an integrated logic circuit of hardware in the processing unit 906 or instructions in the form of software. These instructions may cooperate with other modules for implementation and control. To perform the methods disclosed by the embodiments of the present invention, the processing unit may be a general processor, a digital signal processor (DSP), an application-specific integrated circuit (ASIC), a field-programmable gate array (FPGA) or another programmable logic device, a discrete gate or a transistor logic device, or a discrete hardware component, which can implement or execute the methods, steps, and logical block diagrams disclosed in the embodiments of the present invention. The general processor may be a microprocessor or the processor may also be any conventional processor, decoder, or the like. The steps in the methods disclosed in the embodiments of the present invention may be directly implemented by a hardware processor, or may be implemented by a combination of a hardware module and a software module in the processor. The software module may be located in a mature storage medium in the art, such as a random memory, a flash memory, a read-only memory, a programmable read-only memory or an electrically erasable and programmable memory, or a register. The storage medium is located in the memory 907, and the processing unit reads information in the memory 907, and performs the steps of the methods in combination with hardware of the processing unit.

A person of ordinary skill in the art may understand that all or a part of the steps of the method embodiments may be implemented by a program instructing relevant hardware. The program may be stored in a computer readable storage medium. When the program runs, the steps of the method embodiments are performed. The foregoing storage medium includes: any medium that can store program code, such as a ROM, a RAM, a magnetic disk, or an optical disc.

What is claimed is:

1. A method for switching a station (STA) working mode, the method comprising:
obtaining, by a transmit end, switching information of a STA, wherein the switching information comprises that the STA switches to a traffic indication map station (TIM STA) or the STA switches to a non-traffic indication map station (Non-TIM STA); and
sending, by the transmit end, a first message to a receive end, wherein the first message comprises a flag bit, and the flag bit identifies the switching information.

2. The method according to claim 1, wherein the transmit end is the STA, and the receive end is an access point (AP).

3. The method according to claim 2, wherein after obtaining, by a transmit end, switching information of a STA, the method further comprises:
switching, by the STA, to the TIM STA or the Non-TIM STA according to the switching information.

4. The method according to claim 2, wherein after sending, by the transmit end, a first message to a receive end, the method further comprises:
receiving, by the STA, a response message, sent by the AP, of the first message; and
when the response message comprises a new association identifier (AID), the STA uses the new AID, or when the response message does not comprise a new AID, the STA continues to use an existing AID.

5. The method according to claim 1, wherein the transmit end is an access point (AP), and the receive end is the STA.

6. The method according to claim 5, wherein the first message is a multicast message, and the STA is any STA in a STA group in which all STAs need to switch from Non-TIM STAs to TIM STAs, or any STA in a STA group in which all STAs need to switch from TIM STAs to Non-TIM STAs.

7. The method according to claim 5, wherein the first message comprises a new association identifier (AID), and the method further comprises:
allocating the new AID to the STA, wherein when the STA needs to switch to the TIM STA, a group in which the new AID belongs is a group corresponding to the TIM STA, and when the STA needs to switch to the Non-TIM STA, a group in which the new AID belongs is a group corresponding to the Non-TIM STA.

8. A communications device, comprising:
an obtaining module, configured to obtain switching information of a station (STA), wherein the switching information comprises that the STA switches to a traffic indication map station (TIM STA) or the STA switches to a non-traffic indication map station (Non-TIM STA); and
a sending module, configured to send a first message to a receive end, wherein the first message comprises a flag bit, and the flag bit identifies the switching information.

9. The device according to claim 8, wherein the device is the STA, and the receive end is an access point (AP).

10. The device according to claim 9, further comprising:
a switching module, configured to switch to the TIM STA or the Non-TIM STA according to the switching information.

11. The device according to claim 9, further comprising:
a receiving module, configured to receive a response message, sent by the AP, of the first message; and
a processing module, configured to:
when the response message comprises a new association identifier (AID), start to use the new AID, or
when the response message does not comprise a new AID, continue to use an existing AID.

12. The device according to claim 8, wherein the device is an access point (AP), and the receive end is the STA.

13. The device according to claim 12, wherein the first message is a multicast message, and the STA is any STA in a STA group in which all STAs need to switch from Non-TIM STAs to TIM STAs, or any STA in a STA group in which all STAs need to switch from TIM STAs to Non-TIM STAs.

14. The device according to claim 12, wherein the first message comprises a new association identifier (AID), and the device further comprises:
an allocation module, configured to allocate the new AID to the STA, wherein when the STA needs to switch to the TIM STA, a group in which the new AID belongs is a group corresponding to the TIM STA, and when the STA needs to switch to the Non-TIM STA, a group in which the new AID belongs is a group corresponding to the Non-TIM STA.
